(19) United States
(12) Patent Application Publication
(10) Pub. No.: US 2022/0375049 A1
(43) Pub. Date: Nov. 24, 2022

(54) Reduction of Glare in Endoscopic Images

(71) Applicant: Xiaoning Huai, Sunnyvale, CA (US)

(72) Inventor: Xiaoning Huai, Sunnyvale, CA (US)

(73) Assignee: Real Image Technology Co., Ltd, Shenzhen (CN)

(21) Appl. No.: 17/878,048

(22) Filed: Aug. 1, 2022

(30) Foreign Application Priority Data
Jul. 19, 2022 (CN) 2022218499508

(51) Int. Cl. G06T 5/20

(52) U.S. Cl. CPC G06T 5/20; G06T 2207/20172; G06T 2207/10

(57) ABSTRACT

The present invention provides a method, system and device for reflectional glare reduction in endoscope images. The reflective glare refers to clusters of congruent bright and often saturated image pixels caused by heterogenous surfaces of a tissue anatomy reflecting the illumination from a light source, which could be as annoying as distractive. Under automatic exposure control, in a scene of overexposure due to a reflection glare, the brightness of the glare is significantly higher than that of background image of tissue anatomy, and there is usually a gap between the two. Through mapping the pixel depth of the glare into the gap, the contrast between the glare and the background image is reduced, which improves the user experience of the endoscopy.

### TECHNICAL FIELD

The invention is applied to the field of biomedicine, especially to the processing, noise reduction and enhancement of endoscopic images.

### BACKGROUND TECHNIQUE

Endoscopic images often jump with random snowflake-like glares. Because human eyes are highly sensitive to rapidly changing bright spots in a scenario, doctors are distracted by the dazzling glare when using an endoscope for inspection, which not only easily causes fatigue, but also seriously affects the quality and efficiency of the inspection.

### SUMMARY OF THE INVENTION

The present invention provides a device for endoscopic image glare reduction. The device is configured to acquire a first endoscopic image, and further perform a glare reduction relating to the image by one of the following four modes:

Mode 1: acquire a first saturated pixel in the image, the value of at least one component of luminance, R, G, and B of the pixel is greater than or equal to the upper limit value of the component; determine at least one upper limit mapping value for the upper limit value of the at least one component, wherein the upper limit mapping value is smaller than the upper limit value; replace the at least one upper limit value with the al least one upper limit mapping value respectively, wherein the image after the replacement reduces intensity of the glare by reducing brightness of the glare and contrast between the glare and image background;

Mode 2: acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background; map the at least one component value between the upper limit mapping value and the lower limit mapping value of the at least one component to obtain at least one mapping value; replace the at least one component value with the at least one mapping value respectively, wherein the image after the replacement reduces intensity of the glare by reducing brightness of the glare and contrast between the glare and image background;

Mode 3: determine the image containing one more glares; acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background; map the at least one component value between the upper limit mapping value and the lower limit mapping value of the at least one component to obtain at least one mapping value; replace the at least one component value with the at least one mapping value respectively, wherein the image after the replacement reduces intensity of the glare by reducing brightness of the glare and contrast between the glare and image background;

Mode 4: determine the image containing one more glares; acquire a second image; acquire a second saturated pixel of the second image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background; map the at least one component value between the upper limit mapping value and the lower limit mapping value of the at least one component to obtain at least one mapping value; replace the at least one component value with the at least one mapping value respectively, wherein the image after the replacement reduces intensity of the glare by reducing brightness of the glare and contrast between the glare and image background. Mode 4 applies in a situation where the device may not have an image frame buffer in the ISP apparatus so that when glare is detected in a first image, the first image may have gone through the pipeline and glare reduction may not be applied until the next image is acquired. The image may be determined to contain glares if a total number of the first saturated pixels is larger than a second threshold in any connected domain of the image pixels, or be greater than a third threshold in any neighborhood with a dimension less than n*m.

The device may display or store or output the processed image through a network. The processed image reduces the brightness of the glare and the contrast between the glare and the background image, thereby reducing the intensity of the glare.

For an image with a depth of 8 bits, the upper limit value of each component may be equal to the upper limit value of the image pixel, 255, and for an image with a depth of 10 bits, the upper limit value may be equal to 1023; the second threshold may be [3-255]; the third the threshold can be [6-255]; n can be [5-255]; m can be [5-255]. The mapping may be monotonically increasing, including gamma correction.

The present invention provides a system for endoscopic image glare reduction, including an image acquisition module, an image processing module and an image display module; the image acquisition module is configured to acquire a first endoscopic image, the image processing module is configured to perform a glare reduction relating to the image by one of the following four modes:

Mode 1: acquire a first saturated pixel in the image, the value of at least one component of luminance, R, G, and B of the pixel is greater than or equal to the upper limit value of the component; determine at least one upper limit mapping value for the upper limit value of the at least one component, wherein the upper limit mapping value is smaller than the upper limit value; replace the at least one upper limit value with the al least one upper limit mapping value respectively;

Mode 2: acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background; map the at least one component value between the upper limit mapping value and the lower limit mapping value of the at least one component to obtain at least one mapping value; replace the at least one component value with the at least one mapping value respectively;

Mode 3: determine the image containing one more glares; acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background; map the at least one component value between the upper limit mapping value and the lower limit mapping value of the at least one component to obtain at least one mapping value; replace the at least one component value with the at least one mapping value respectively;

Mode 4: determine the image containing one more glares; acquire a second image via the image acquisition module; acquire a second saturated pixel of the second image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background; map the at least one component 1 value between the upper limit mapping value and the lower limit mapping value of the at least one component to obtain at least one mapping value; replace the at least one component value with the at least one mapping value respectively.

The image may be determined to contain glares if a total number of the first saturated pixels is larger than a second threshold in any connected domain of the image pixels, or be greater than a third threshold in any neighborhood with a dimension less than n*m. The image processing module may store the processed image or output the processed image through a network. The processed image reduces intensity of the glare by reducing brightness of the glare and contrast between the glare and image background.

The image processing module may be configured to store or output the processed image through the network. The display module is configured to display the processed image. The image may be determined to contain glares if a total number of the first saturated pixels is larger than a second threshold in any connected domain of the image pixels, or be greater than a third threshold in any neighborhood with a dimension less than n*m. For an image with a depth of 8 bits, the upper limit value of each component can be equal to the upper limit value of the image pixel 255, and for an image with a depth of 10 bits, the upper limit value is the limit can be equal to 1023; the third threshold can be [3-255]; the fourth threshold can be [6-255]; n can be [5-255]; m can be [5-255]. The mapping may be monotonically increasing, including gamma correction.

The present invention provides a method for endoscopic image glare reduction, comprising the following steps:

Step 1: obtaining a first endoscopic image by a device or an image acquisition module;

Step 2: by the device or an image processing module and via any of the following modes, performing glare reduction relating the image:

Mode 1:

S11: acquiring a first saturated pixel in the image, the value of at least one component of luminance, R, G, and B of the pixel is greater than or equal to the upper limit value of the component;

S12: determining at least one upper limit mapping value for the upper limit value of the at least one component, wherein the upper limit mapping value is smaller than the upper limit value;

S13: replacing the at least one component value with the at least one upper limit mapping value, respectively, wherein the image after the replacement reduces intensity of the glare by reducing brightness of the glare and contrast between the glare and image background;

Mode 2:

S21: acquiring a second saturated pixel of the image, the value of at least one component of luminance, R, G, and B of the second saturated pixel is greater than or equal to a saturation threshold of the component;

S22: determining at least one upper limit mapping value for the upper limit value of the at least one component, wherein the upper limit mapping value is smaller than the upper limit value, and determining at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background;

S23: map respectively the at least one component value between the upper limit mapping value and the lower limit mapping value of the at least one component to obtain at least one mapping value;

S24: replacing respectively the at least one component value with the at least one mapping value, wherein the image after the replacement reduces intensity of the glare by reducing brightness of the glare and contrast between the glare and image background;

Mode 3:

S31: determining the image containing one or more glares;

S32: acquiring a second saturated pixel of the image, the value of at least one component of luminance, R, G, and B of the second saturated pixel is greater than or equal to a saturation threshold of the component;

S33: determining at least one upper limit mapping value for the upper limit value of the at least one component, wherein the upper limit mapping value is smaller than the upper limit value, and determining at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background;

S34: map respectively the at least one component value between the upper limit mapping value and the lower limit mapping value of the at least one component to obtain at least one mapping value;

S35: replacing respectively the at least one component value with the at least one mapping value, wherein the image after the replacement reduces intensity of the glare by reducing brightness of the glare and contrast between the glare and image background;

Mode 4:

S41: determining the image containing one or more glares;

S42: acquiring a second image,

S43: acquiring a second saturated pixel of the second image, the value of at least one component of luminance, R, G, and B of the second saturated pixel is greater than or equal to a saturation threshold of the component;

S44: determining at least one upper limit mapping value for the upper limit value of the at least one component, wherein the upper limit mapping value is smaller than the upper limit value, and determining at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background;

S45: map respectively the at least one component value between the upper limit mapping value and the lower limit mapping value of the at least one component to obtain at least one mapping value;

S46: replacing respectively the at least one component value with the at least one mapping value, wherein the image after the replacement reduces intensity of the glare by reducing brightness of the glare and contrast between the glare and image background;

Step 3: displaying, or storing the processed image, or outputting the processed image through a network.

The method further comprises the steps of determining the first image containing glares if a total number of the first saturated pixels is larger than a second threshold in any connected domain of the image pixels, or be greater than a third threshold in any neighborhood with a dimension less than n*m.

For an image with a depth of 8 bits, the upper limit value of each component can be equal to the upper limit value of the image pixel 255, and for an image with a depth of 10 bits, the upper limit value is the limit can be equal to 1023; the third threshold can be [3-255]; the fourth threshold can be [6-255]; n can be [5-255]; m can be [5-255].

The mapping may be monotonically increasing, including gamma correction.

The positive effect of the present invention is that by reducing the intensity of the glare the quality and efficiency of endoscopy are improved.

### DESCRIPTION OF DRAWINGS

FIG. 1 is a diagram of the structure of the device and the system

FIG. 2a-2b are illustrations of the algorithms

FIG. 3 is a schematic diagram of luminance mapping.

FIG. 4 is a schematic diagram of R component mapping.

FIG. 5 is a schematic diagram of G component mapping.

FIG. 6 is a schematic diagram of B component mapping.

### DETAILED DESCRIPTION

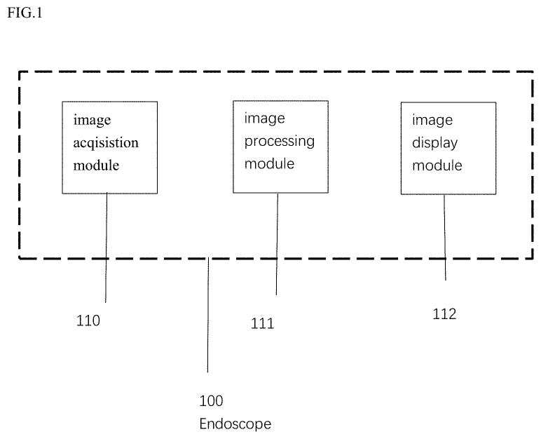

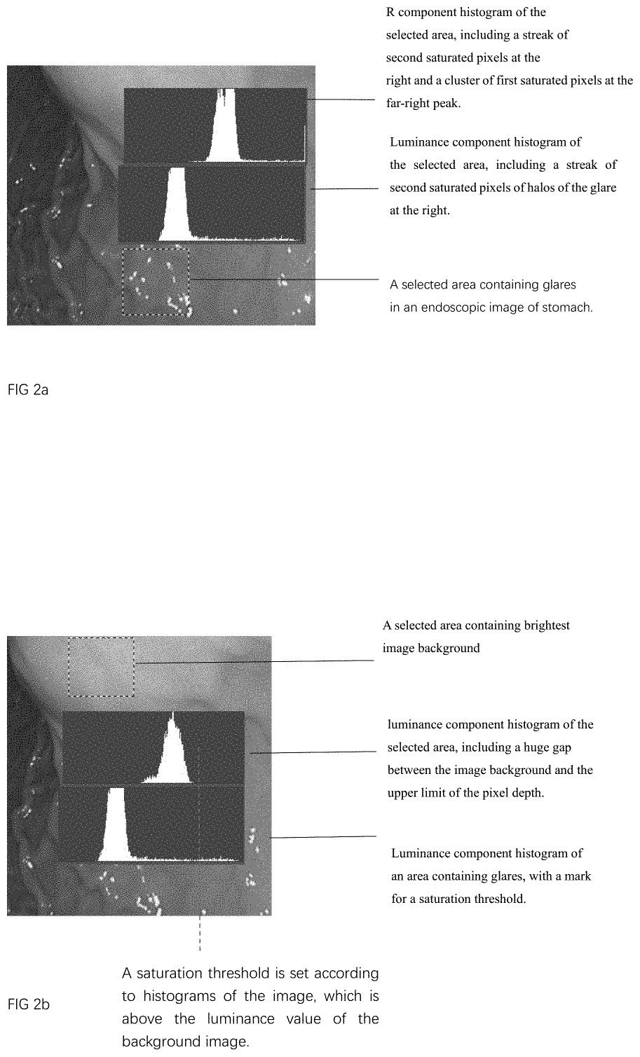

The following description is for illustrating the present invention without limiting it. As shown in FIG. 1, the device may include an endoscope. The endoscope may include an image acquisition module, an image processing module and an image display module. The image acquisition module may include a lens and an image sensor; the image processing module may include an ISP processor, and/or at least one processor, and a non-volatile and dynamic data storage medium stores the instructions, parameters and data accessible by the processor. The processor or a hardware module can run a program to realize the glare reduction function of the present invention. The program may be an integral part of the operation of the endoscope. The endoscope can also be controlled and data can be transmitted via the network. The display module includes at least one monitor. FIGS. 2a and 2b relate to a gastroscopic image of a subject, including multiple glare clusters, and the histogram shows that there is a streak between the luminance of the image background and the glare. This is due to reflective glare appears at edges and corners of the tissue surface or associated with body fluids under automatic exposure control, wherein the brightness of the glare is significantly higher than that of the background image of the tissue anatomy, and there is usually a halo zone predominantly occupied by the glare. Mapping the brightness of the glare into the halo zone can reduce the brightness of the glare and contrast between the glare and the background image and consequently reduce the intensity of the glare.

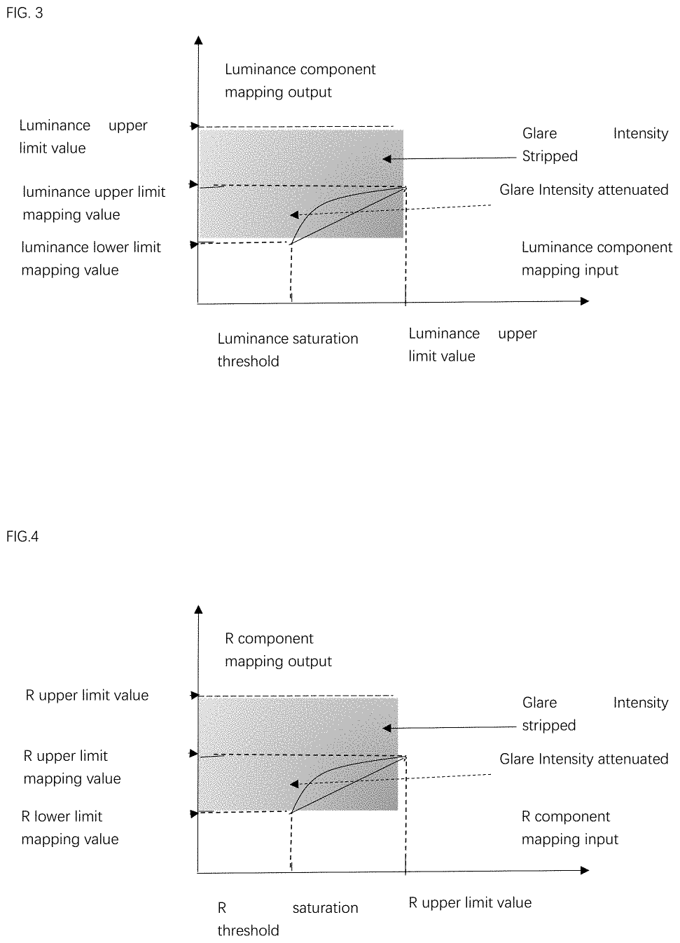

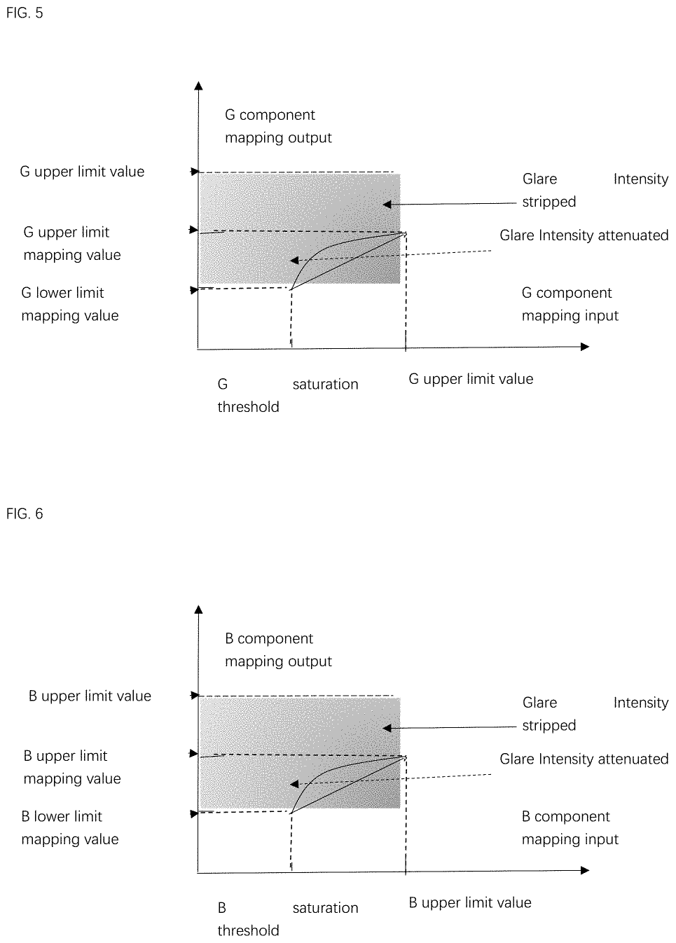

After acquiring a first endoscopic image, the endoscope can use any one of the modes described above to perform glare reduction relating the image. The upper limit values, the saturation thresholds, the upper limit and lower limit mapping values and other threshold values may be independent though possibly be correlated parameters that can be loaded to the processor of the endoscope before it is used for inspection or be determined by a program automatically through analysis of the images. For example, for an 8-bit image depth, the upper limit value of each component can be set to equal to 255, the upper limit mapping value of each component can be set to 245; the saturation threshold value of each component can be set to 217; The lower limit mapping value of each component can be set to is 237. The second threshold can be set to 6; the third threshold can be set to 9; n can be set to 9; m can be set to 9. Monotonically increasing mapping may be used to maintain spatial tonal relationships between image contents such as the gamma correction, which may be implemented as a look up table in ISP pipeline. FIG. 3 illustrate the mapping transformation for the luminance component, while FIG. 4-6 are for the R, G, B components, wherein the intensity of the glare is stripped out between the upper limit value and the upper limit mapping value. The luminance and the R, G, B components can be correlated by a linear transformation.

Referring the mapping algorithm illustrated by FIG. 3,

Let Lₒᵤₜ be presentative of the luminance component mapping output value, Lᵢₙ be presentative of the luminance component input value, Lᵤₗ be representative of the upper limit value of the luminance component; Lᵤₗₘ be representative of the upper limit mapping value of the luminance component; Lₛₐ be representative of the saturation threshold of the luminance component; and Lₗₗₘ be representative of the lower limit mapping value of the luminance component;

Lₒᵤₜ=Lₗₗₘ+(Lᵤₗₘ−Lₗₗₘ)*((Lᵢₙ−Lₛₐ)/(Lᵤₗ−Lₛₐ))^{γ}; [1]

Wherein Lₛₐ≤Lᵢₙ≤Lᵤₗ; Lₗₗₘ≤Lₒᵤₜ≤Lᵤₗₘ<Lul ; γ is a user-selectable parameter.

When the luminance value or R, G, B component value of the pixel of the image is less than a respective saturation threshold, the value of the gamma table can preferably use the original value of the system or device without the function of the glare reduction, such as 0.45, or a combination of the original value of the value for glare reduction mapping. When the luminance value or R, G, B component value of the image pixel is greater than or equal to the respective saturation threshold, the value of the gamma table can be preferably set with a different value for glare reduction, such as 0.55.

The acquired image can also be stored in a cache, and the mapping transformation be implemented by a dedicated hardware logic circuit or the processor or a different processor on a different platform than the endoscope. The processed images may be displayed on the monitor for viewing by the examining doctor. Further intelligent processing may include, for example, algorithms based on histogram analysis for finer identification and segmentation of the glares and for local mapping.

1. A device for endoscopic image glare reduction, wherein the device is configured to acquire a first endoscopic image, and further perform a glare reduction relating to the image by one of the following four modes:
Mode 1: acquire a first saturated pixel in the image, the value of at least one component of luminance, R, G, and B of the pixel is greater than or equal to the upper limit value of the component; determine at least one upper limit mapping value for the upper limit value of the at least one component, wherein the upper limit mapping value is smaller than the upper limit value; replace the at least one upper limit value with the al least one upper limit mapping value respectively;
Mode 2: acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, map the at least one component value between the upper limit mapping value and the lower limit mapping value of the at least one component to obtain at least one mapping value; replace the at least one component value with the at least one mapping value respectively;
Mode 3: determine the image containing one or more glares; acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, map the at least one component value between the upper limit mapping value and the lower limit mapping value of the at least one component to obtain at least one mapping value; replace the at least one component value with the at least one mapping value respectively;
Mode 4: determine the image containing one or more glares; acquire a second image; acquire a second saturated pixel of the second image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, map the at least one component value between the upper limit mapping value and the lower limit mapping value of the at least one component to obtain at least one mapping value; replace the at least one component value with the at least one mapping value respectively.

2. The device of claim 1, wherein the device is further configured to determine the image containing one or more glares if a total number of the first saturated pixels is larger than a second threshold in any connected domain of the image pixels, or be greater than a third threshold in any neighborhood with a dimension less than n*m.

3. The device of claim 2, further comprising one or more of: the second threshold equals 6; the third threshold equals 9; n equals 9; m equals 9.

4. The device of claim 1, wherein the device is configured to display or store the processed image or output the processed image through a network.

5. The device of claim 1, further comprising one or more of: the saturation threshold is greater than half or two thirds of the upper limit value; for the image with a depth of 8 bits, the upper limit value of each component is equal to 255; for the image with a depth of 10 bits, the upper limit value is equal to 1023; the mapping includes a monotonically increasing mapping; the mapping includes a gamma correction.

6. The device of claim 1, wherein the image after the replacing reduces intensity of the glare by reducing brightness of the glare and contrast between the glare and image background.

7. A system for endoscopic image glare reduction, including an image acquisition module and an image processing module; the image acquisition module is configured to acquire a first endoscopic image; the image processing module is configured to perform a glare reduction relating to the image by one of the following four modes:
Mode 1: acquire a first saturated pixel in the image, the value of at least one component of luminance, R, G, and B of the pixel is greater than or equal to the upper limit value of the component; determine at least one upper limit mapping value for the upper limit value of the at least one component, wherein the upper limit mapping value is smaller than the upper limit value; replace the at least one upper limit value with the al least one upper limit mapping value respectively;
Mode 2: acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, map the at least one component value between the upper limit mapping value and the lower limit mapping value of the at least one component to obtain at least one mapping value; replace the at least one component value with the at least one mapping value respectively;
Mode 3: determine the image containing one more glares; acquire a second saturated pixel of the image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component; map the at least one component value between the upper limit mapping value and the lower limit mapping value of the at least one component to obtain at least one mapping value; replace the at least one component value with the at least one mapping value respectively;
Mode 4: determine the image containing one more glares; acquire a second image via the image acquisition module; acquire a second saturated pixel of the second image, the value of at least one component of luminance, R, G, and B of the second saturated pixel is greater than or equal to a saturation threshold of the component; determine at least one upper limit mapping value for the upper limit value of the at least one component, wherein the upper limit mapping value is smaller than the upper limit value; determine at least one lower limit mapping value corresponding to the saturation threshold of the at least one component, wherein, the upper limit mapping value of any component is greater than the lower limit mapping value of the component, map the at least one component value between the upper limit mapping value and the lower limit mapping value of the at least one component to obtain at least one mapping value; replace the at least one component value with the at least one mapping value respectively;

8. The system of claim 7, wherein the image processing module is further configured to determine the image containing one or more glares if a total of the first saturated pixels is larger than a second threshold in any connected domain of the image pixels, or be greater than a third threshold in any neighborhood with a dimension less than n*m.

9. The system of claim 8, further comprising one or more of: the second threshold equals 6; the third threshold equals 9; n equals 9 and m equals 9.

10. The system of claim 7, further comprising an image display module configured to display the processed image, wherein the image processing module is configured to store the processed image or output the processed image through a network.

11. The system of claim 7, wherein the image after the replacing reduces intensity of the glare by reducing brightness of the glare and contrast between the glare and image background.

12. The system of claim 7, further comprising one or more of: wherein the saturation threshold of a component is greater than half or two thirds of the upper limit value of the component; for the image with a depth of 8 bits, the upper limit value of each component is equal to 255; for the image with a depth of 10 bits, the upper limit value is equal to 1023; the mapping includes a monotonically increasing mapping; the mapping includes a gamma correction.

13. A method for endoscopic image glare reduction, comprising the following steps:
Step 1: obtaining a first endoscopic image by a device or an image acquisition module;
Step 2: by the device or an image processing module and via any of the following modes, performing glare reduction relating the image:
Mode 1:
S11: acquiring a first saturated pixel in the image, the value of at least one component of luminance, R, G, and B of the pixel is greater than or equal to the upper limit value of the component;
S12: determining at least one upper limit mapping value for the upper limit value of the at least one component, wherein the upper limit mapping value is smaller than the upper limit value;
S13: replacing the at least one component value with the at least one upper limit mapping value respectively;
Mode 2:
S21: acquiring a second saturated pixel of the image, the value of at least one component of luminance, R, G, and B of the second saturated pixel is greater than or equal to a saturation threshold of the component;
S22: determining at least one upper limit mapping value for the upper limit value of the at least one component, wherein the upper limit mapping value is smaller than the upper limit value, and determining at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background;
S23: map respectively the at least one component value between the upper limit mapping value and the lower limit mapping value of the at least one component to obtain at least one mapping value;
S24: replacing respectively the at least one component value with the at least one mapping value;
Mode 3:
S31: determining the image containing one or more glares;
S32: acquiring a second saturated pixel of the image, the value of at least one component of luminance, R, G, and B of the second saturated pixel is greater than or equal to a saturation threshold of the component;
S33: determining at least one upper limit mapping value for the upper limit value of the at least one component, wherein the upper limit mapping value is smaller than the upper limit value, and determining at least one lower limit mapping value corresponding to the saturation threshold of the at least one component, wherein, the upper limit mapping value of any component is greater than the lower limit mapping value of the component, and the saturation threshold of a component is greater than half or two thirds of the upper limit value of the component, the saturation threshold of the luminance component can preferably be greater than luminance value of the image background;
S34: map respectively the at least one component value between the upper limit mapping value and the lower limit mapping value of the at least one component to obtain at least one mapping value;
S35: replacing respectively the at least one component value with the at least one mapping value;
Mode 4:
S41: determining the image containing one or more glares;
S42: acquiring a second image,
S43: acquiring a second saturated pixel of the second image, the value of at least one component of luminance, R, G, and B of the second saturated pixel is greater than or equal to a saturation threshold of the component;
S44: determining at least one upper limit mapping value for the upper limit value of the at least one component, wherein the upper limit mapping value is smaller than the upper limit value, and determining at least one lower limit mapping value corresponding to the saturation threshold of the at least one component, wherein, the upper limit mapping value of any component is greater than the lower limit mapping value of the component;
S45: map respectively the at least one component value between the upper limit mapping value and the lower limit mapping value of the at least one component to obtain at least one mapping value;
S46: replacing respectively the at least one component value with the at least one mapping value;
Step 3: displaying or storing the processed image, or outputting the processed image through a network.

14. The method of claim 13, further comprising the steps of:
determining the first image containing glares if a total number of the first saturated pixels is larger than a second threshold in any connected domain of the image pixels, or be greater than a third threshold in any neighborhood with a dimension less than n*m.

15. The method of claim 14, further comprising one or more of: the second threshold is 6; the third threshold is 9; n is equal to 9; m is equal to 9.

16. The method of claim 13, further comprising one or more of: the saturation threshold is greater than half or two thirds of the upper limit value; for the image with a depth of 8 bits, the upper limit value of each component is equal to 255; for the image with a depth of 10 bits, the upper limit value is equal to 1023.

17. The method of claim 13, wherein the mapping includes a monotonically increasing mapping.

18. The method of claim 13, wherein the mapping includes a gamma correction.

19. The method of claim 13, wherein the saturation threshold of a component is greater than half or two thirds of the upper limit value of the component.

20. The method of claim 13, wherein the image after the replacing reduces intensity of the glare by reducing brightness of the glare and contrast between the glare and image background.
